(19) United States
(12) Patent Application Publication
(10) Pub. No.: US 2009/0210301 A1
(43) Pub. Date: Aug. 20, 2009

(54) GENERATING CUSTOMIZED CONTENT BASED ON CONTEXT DATA

(75) Inventors: Erik Porter, Kirkland, WA (US); Tobin R. Titus, Issaquah, WA (US); Ernest A. Booth, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/031,683

(22) Filed: Feb. 14, 2008

(51) Int. Cl. G06Q 30/00; G06F 17/30

(52) U.S. Cl. 705/14; 707/102; 707/3; 707/5; 707/E17.044; 707/E17.108

(57) ABSTRACT

Technologies are described herein for providing customized content based on context data from a participant of a virtual world. The context data based on participation by the participant of the virtual world is received. The customized content for the participant is generated based on the context data. The customized content is provided to the participant via the virtual world.

### BACKGROUND

In recent years, massively multiplayer online (“MMO”) computer applications, such as massively multiplayer online role-playing games (“MMORPGs”), have become extremely popular not only with serious gamers, but also with casual gamers and other Internet users. One example of a MMO computer application enables a participant to create and develop a fictional character in a virtual world. The fictional character is usually associated with an avatar or some other visual representation that enables other participants to recognize the particular fictional character. A given participant may develop, among other things, a storyline, a reputation, and attributes of her fictional character by interacting in the virtual world via the fictional character. Other examples of MMO computer applications may not involve the creation of a virtual world representation of the participant.

The virtual world typically includes an environment with a variety of virtual locations containing a variety of virtual objects. In some cases, the virtual locations and the virtual objects mimic realistic locations and objects, while in other cases, the virtual locations and virtual objects are fanciful creations. MMO computer applications generally permit the fictional character to travel across the virtual locations and interact with the virtual objects and other fictional characters.

Advertising in the modern age has proven to be increasingly challenging. In particular, conventional advertising techniques have become less effective especially in recent times. Consumers are now provided with substantially more entertainment options than just a few years ago, thereby reducing the number of consumers that are exposed to a given advertisement. Further, new technologies, such as portable music players, satellite radio, and digital video recorders (“DVRs”), have allowed the users to avoid or skip conventional advertisements entirely.

As advertisers try to find ways to reach more consumers, one advertising medium that has become more attractive are virtual worlds, like MMO computer applications. The number of participants in MMO computer applications has steadily increased in recent times, and this trend shows little, if any, signs of reversing. Further, MMO computer applications provide a single entertainment destination for many Internet users and gamers, thereby enabling advertisers to reach a larger number of consumers through a single advertising medium. As computer and Internet technologies continue to improve to provide more and better ways to include real-world advertisements within the virtual world, MMO computer applications will continue to grow as a significant advertising medium.

It is with respect to these considerations and others that the disclosure made herein is presented.

### SUMMARY

Technologies are described herein for providing customized content to a participant of a virtual world. In particular, through the utilization of the technologies and concepts presented herein, a content provider may acquire from another source and/or directly collect context data associated with the participant. The context data may include any suitable data related to the participation by the participant of the virtual world. Examples of the customized content include customized advertisements and customized search results. By customizing the advertisements and search results based on the context data, the advertisements and search results can be better targeted and more relevant to the participant.

According to one aspect presented herein, a computer program provides customized content based on context data from a participant of a virtual world. The computer program receives the context data based on participation by the participant of the virtual world. The computer program generates the customized content for the participant based on the context data and provides the customized content to the participant via the virtual world.

It should be appreciated that although the features presented herein are described in the context of a MMO computer application, these features may be utilized with any type of virtual world or environment including, but not limited to, other types of games as well as online social communities. It should also be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network architecture diagram showing aspects of a network architecture capable of implementing a virtual world, such as a massively multiplayer online role-playing game;

FIG. 2A is a screen display diagram showing an illustrative screenshot of a customized advertisement, in accordance with one embodiment.

FIG. 2B is a screen display diagram showing an illustrative screenshot of customized search results, in accordance with one embodiment;

FIG. 3A is a flow diagram showing aspects of an illustrative process for providing the customized advertisement, in accordance with one embodiment;

FIG. 3B is a flow diagram showing aspects of an illustrative process for providing customized search results, in accordance with one embodiment; and

FIG. 4 is a computer architecture diagram showing aspects of an illustrative computer hardware architecture for a computing system capable of implementing aspects of the embodiments presented herein.

### DETAILED DESCRIPTION

The following detailed description is directed to technologies for providing customized content to a participant of a virtual world based on context data associated with the participant. Through the utilization of the technologies and concepts presented herein, a content provider can provide customized content to the participant that is more targeted and more relevant. In one example, an advertiser can provide a customized advertisement to the participant based on the context data. In another example, a search engine can provide more relevant and better ranked results to the participant based on the context data.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

As used herein, the term virtual world refers to a computer-implemented environment, which may include simulated, lifelike environments as well as fanciful, non-existing environments. Exemplary virtual worlds may include any massively multiplayer online (“MMO”) computer application including, but not limited to, massively multiplayer online role-playing games (“MMORPGs”), virtual social communities, and virtual reality computer applications. In one embodiment, the MMO computer application simulates a real world environment. For example, the virtual world may be defined by a number of rules, such as the presence of gravity or the lack thereof. In other embodiments, the MMO computer application includes a fanciful environment that does not simulate a real world environment.

The virtual world may be inhabited by avatars, which are virtual or symbolic representations of real world participants (hereinafter referred to as participants). As such, each avatar is typically associated with and controlled by a particular participant. Avatars may include two-dimensional and/or three-dimensional images. Through the virtual world, the avatars may interact with other avatars, as well as with virtual objects. Virtual objects may include virtual representations of real world objects, such as houses, cars, billboards, clothes, and soda cans, as well as fanciful creations, such as a teleportation machine or a flying car. The avatars and the virtual objects utilized in the virtual world may or may not be animated images.

As used herein, the term “context data” may include any suitable data associated with the participation by the participant of the virtual world. The context data may include current data as well as historical data dating back to a previous time. For example, the context data may include locations within the virtual world that the participant has visited, the other participants of the virtual world with which the participant has interacted or communicated, and the purchases or other commercial transactions the participant has made via the virtual world.

To further increase the effectiveness of the context data, the context data may also include other relevant data retrieved from the computer utilized by the participant to access the virtual world. In one example, the context data may include data associated with the participant's web browsing habits. In this case, the context data may include, among other information, the websites that the participant has visited and the amount of time the participant spends at each website. In another example, the context data may include the location of the participant.

For the sake of simplicity, the embodiments described herein primarily refer to the application of context data for providing customized advertisements and customized search results via the virtual world. However, it should be appreciated that other types of customized content may be provided to the participant. Further, the customized content may be provided to the participant apart from the virtual world. In particular, the context data may be utilized to customize any suitable content where data regarding the participant's interaction via a computer or a particular computer application is relevant.

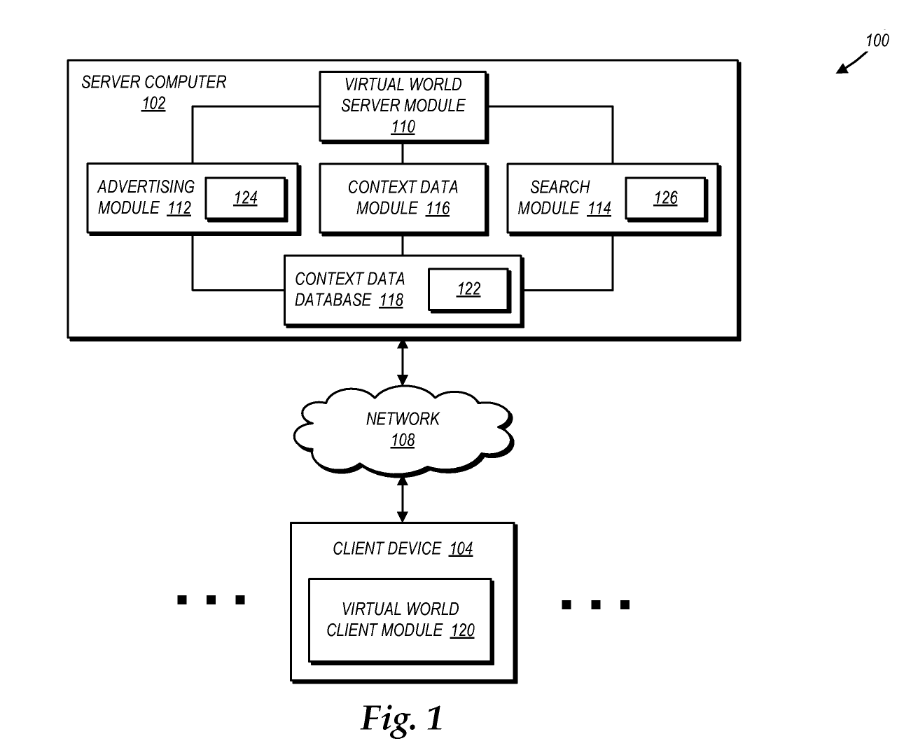

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for providing advertising in a virtual world will be described. In particular, FIG. 1 illustrates a simplified network architecture 100 for implementing a virtual world. The network architecture 100 shown in FIG. 1 includes a server computer 102 and a client device 104, each of which is operatively coupled via a network 108. The network 108 may be any suitable network, such as a local area network (“LAN”) or the Internet. Although only one client device 104 is illustrated in FIG. 1, the network architecture 100 may include multiple client devices and multiple computing devices in any suitable network configuration.

The client device 104 may be any suitable processor-based device, such as a computer or a gaming device. Exemplary gaming devices include the XBOX and the XBOX 360 from MICROSOFT CORPORATION, the WII from NINTENDO COMPANY, LIMITED, and the PLAYSTATION 3 and the PSP from SONY CORPORATION. Although not so illustrated in FIG. 1, the client device 104 may be coupled to any suitable peripheral devices to enable the participant to experience and interact with the virtual world. Exemplary peripheral devices may include an input device, such as a keyboard, a mouse, a microphone, and a game controller, and an output device, such as a display and speakers. Some peripheral devices may even provide both input and output functionality. For example, a game controller may provide vibration feedback.

As shown in FIG. 1, the client device 104 includes a virtual world client module 120, which interacts with the virtual world server module 110 executing on the server computer 102. In particular, the virtual world client module 120 may receive and process data from virtual world server module 110 and output the data to output devices coupled to the client device 104. Further, the virtual world client module 120 may receive data from input devices coupled to the client device 104 and transmit the data to the virtual world server module 110.

The virtual world client module 120 may include any suitable component for accessing the virtual world server module 110. In one example, the virtual world client module 120 may be a computer application configured to locally provide at least a portion of the virtual world for the client device 104. In this way, the amount of data retrieved from the server computer 102 by the client device 104 to generate the virtual world may be reduced. In another example, the virtual world client module 120 may be a web browser configured to retrieve the virtual world from the virtual world server module 110. Since many public computers, such as those found in Internet cafes, commonly have a web browser installed and prohibit the installation of new computer applications, providing participants a way to access the virtual world via the web browser may provide greater accessibility and convenience.

As shown in FIG. 1, the server computer 102 includes a virtual world server module 110, an advertising module 112, a search module 114, a context data module 116, and a context data database 118. The virtual world server module 110 generally administers the virtual world and serves as a conduit between multiple client devices, including the client device 104. The context data module 116 generally collects context data 122 via the virtual world server module 110. In particular, as the participant accesses the virtual world via the virtual world client module 120 and the virtual world server module 110, the context data module 116 collects the context data 122 and stores the context data 122 in the context data database 118. The context data 122 may include any suitable information associated with the participant's interaction with the virtual world including, but not limited to, the locations within the virtual world that the participant has visited, the other participants and avatars with which the participant has interacted or communicated, and the purchases or other commercial transactions that the participant has made within the virtual world.

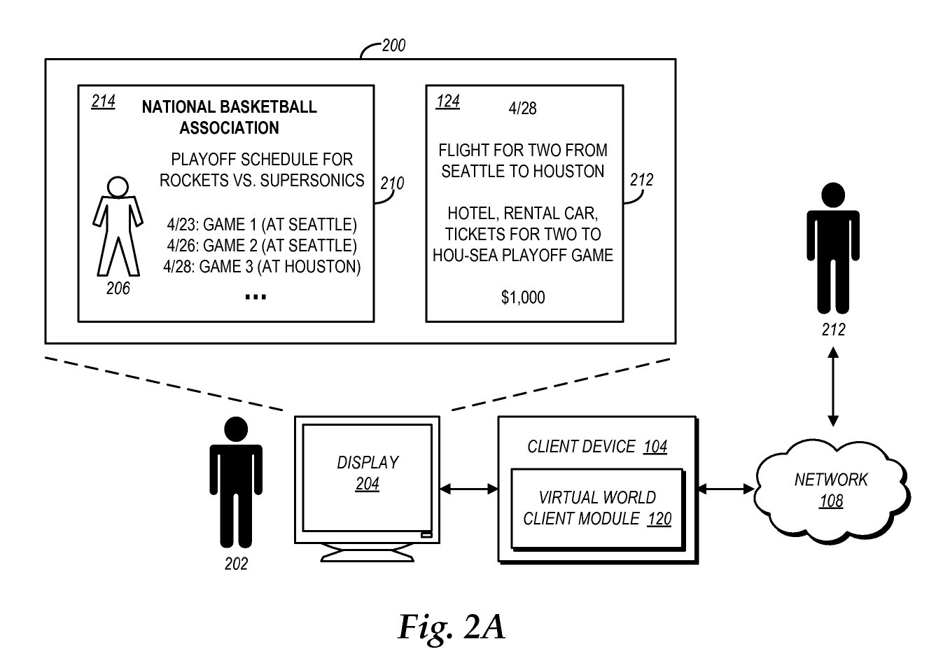

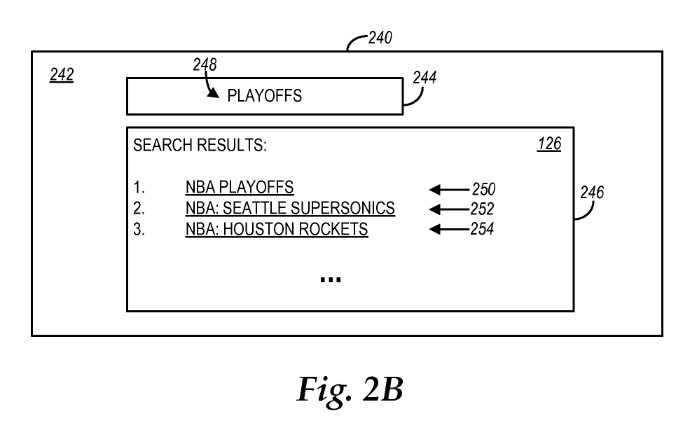

Once the context data 122 has been collected by the context data module 116 and stored in the context data database 118, the context data 122 may be utilized by advertising module 112 and the search module 114. According to exemplary embodiments, the advertising module 112 generates a customized advertisement 124, in accordance with the context data 122, and provides the customized advertisement 124 to the participant via the virtual world client module 120 and the virtual world server module 110. Further, according to exemplary embodiments, the search module 114 generates customized search results 126, in accordance with the context data 122, and provides the customized search results 126 to the participant via the virtual world client module 120 and the virtual world server module 110. The operations of the advertising module 112, the search module 114, and the context data module 116 are described in greater detail below with reference to FIGS. 2A, 2B, 3A, 3B, and 4.

When a participant desires to access the virtual world, the participant may initiate the virtual world client module 120 to establish a session with the virtual world server module 110 via the network 108. During the session, the virtual world server module 110 may transmit data (e.g., environment layouts, avatar movements of other participants) associated with the virtual world to the virtual world client module 120. Similarly, the virtual world client module 120 may transmit data from associated input devices to the virtual world server module 110. The virtual world client module 120 may further interact with the advertising module 112 to provide the customized advertisement 124 or the search module 114 to provide the customized search results 126 to the participant via the virtual world. Alternatively, the virtual world server module 110 may act as a conduit between the virtual world client module 120 and the advertising module 112 or between the virtual world client module 120 and the search module 114 such that virtual world client module 120 need not directly communicate with the advertising module 112 or the search module 114.

Turning now to FIG. 2A, an illustrative screenshot 200 of a virtual world provided by the virtual world server module 110 and the virtual world client module 120 is shown, in accordance with one embodiment. A participant 202 may view the screenshot 200 on a display 204 operatively coupled to the client device 104. As shown in FIG. 2A, the screenshot 200 illustrates an avatar 206. The avatar 206 is associated with and controlled by the participant 202 via the client device 104. In one embodiment, the participant 202 controls the movement of the avatar 206 within the virtual world via an input device (not shown), such a keyboard, mouse, and game controller, operatively coupled to the client device 104.

In an illustrative example, the screenshot 200 includes virtual world window 210 and an advertisement window 212. As shown in FIG. 2A, the avatar 206 is interacting within a NATIONAL BASKETBALL ASSOCIATION (“NBA”) virtual world 214 inside the virtual world window 210. In particular, the avatar 206 is viewing the playoff schedule between the HOUSTON ROCKETS and the SEATTLE SUPERSONICS. In this case, the context data 122 collected by the context data module 116 may include data indicating that the avatar 206 visited the NBA virtual world. The context data 122 may further include data indicating that the avatar 206 accessed the playoff schedule for the playoff series between the HOUSTON ROCKETS and the SEATTLE SUPERSONICS.

The context data 122 may also include personal data about the participant 202 who controls the avatar 206. For example, the context data 122 may include data regarding where the participant 202 is located. The location of the participant 202, as well as other relevant data, may be determined by a variety of ways including, but not limited to, a questionnaire filled out by the participant 202, an Internet Protocol (“IP”) address associated with the client device 104, or a Hypertext Transfer Protocol (“HTTP”) cookie transmitted to the participant 202 via the client device 104. Other examples of relevant personal data may include the income of the participant 202, the marital status of the participant 202, and data indicating a level of interest in the SEATTLE SUPERSONICS, the HOUSTON ROCKETS, or the NBA in general (e.g., previous ticket purchases). For the sake of illustration, it is assumed that the context data 122 includes data indicating that the participant 202 is located in the Seattle area, is an avid SEATTLE SUPERSONICS fan with a high income, and is married.

Upon collecting the context data 122, the context data module 116 may store the context data 122 in the context data database 118. In one embodiment, the context data 122 is associated with the participant 202. Thus, multiple participants may each be associated with a particular set of context data. The context data 122 may include current information (e.g., a concurrent instance of the virtual world) and/or historical information (e.g., prior instances of the virtual world).

Continuing with the illustrative example, the advertising module 112 may analyze the context data 122 to generate the customized advertisement 124. As illustrated in FIG. 2, the customized advertisement 124 advertises a travel package coinciding with the playoff game between the HOUSTON ROCKETS and the SEATTLE SUPERSONICS on April 28. The travel package includes a flight for two from the Seattle to Houston, hotel, rental car, and two tickets to the playoff game. The customized advertisement 124 is customized to the location of the participant 202 (i.e., Seattle) as well as the interests and qualities of the participant 202 (i.e., married, avid fan of the SEATTLE SUPERSONICS).

In one embodiment, the customized advertisement 124 includes a link to a website at which the participant 202 can purchase the advertised vacation package. In another embodiment, the customized advertisement 124 enables the participant 202 to purchase the vacation package within the virtual world. The customized advertisement 124 may be in any suitable multimedia format, such as text, images, audio, video, or a combination thereof.

Turning now to FIG. 2B, another illustrative screenshot 240 of the virtual world provided by the virtual world server module 110 and the virtual world client module 120 is shown, in accordance with one embodiment. As illustrated in FIG. 2B, the screenshot 240 illustrates a search engine interface 242, which includes an input window 244 and a results window 246. The input window 244 enables the participant 202 to input one or more search terms 248. For example, the participant 202 has input “playoffs” as the search term 248 in the input window 244. The results window 246 displays the customized search results 126 generated by the search module 114.

The search module 114 receives the search term 248 from the input window 244 and generates the customized search results 126 based on the context data 122 and the search term 248. The customized search results 126 may also be ranked based on the context data 122. The search module 114 may be a commercial search engine, such as GOOGLE search, or a non-commercial search engine, such as a dedicated search engine within the virtual world. Search engines are well-known in the art, and therefore not described in further detail herein.

As illustrated in FIG. 2B, the customized search results 126 includes a first search result 250 for a website associated with the NBA playoffs, a second search result 252 for a website associated with the SEATTLE SUPERSONICS, and a third search result 254 for a website associated with the HOUSTON ROCKETS. Since the participant 202 was viewing the playoff schedule in the NBA virtual world 214, the search module 114 determines that the search term “playoffs” relates to the NBA playoffs and returns the first search result 250. Since the participant 202 was viewing the playoff schedule between the HOUSTON ROCKETS and the SEATTLE SUPERSONICS, the search module 114 also determines that the search term “playoffs” relates to the SEATTLE SUPERSONICS and the HOUSTON ROCKETS and returns the second search result 252 and the third search result 254, respectively.

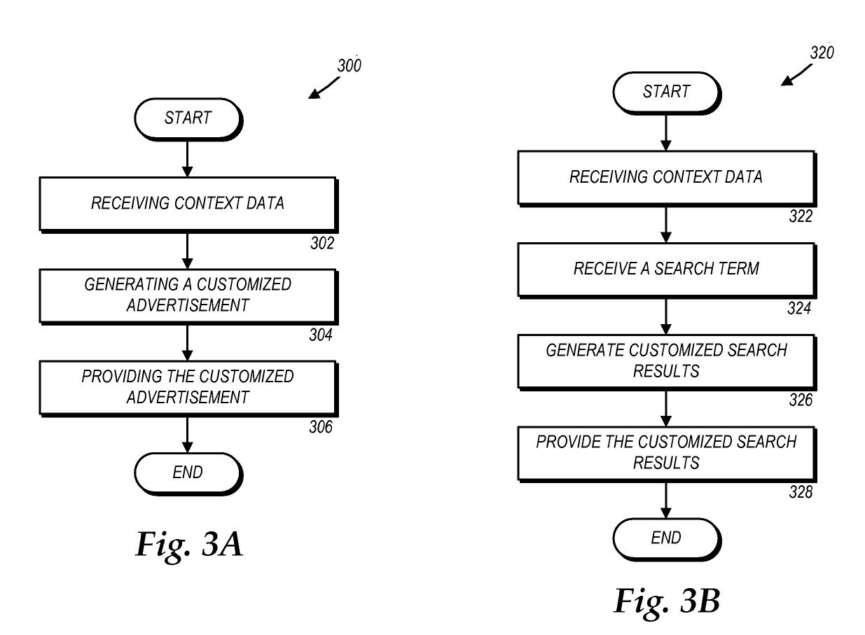

Referring now to FIG. 3, additional details will be provided regarding the embodiments presented herein for providing customized content, such as the customized advertisement 124 and the customized search results 126, to the participant 202. In particular, FIG. 3A is a flow diagram illustrating aspects of one method provided herein for providing the customized advertisement 124 to the participant 202. Further, FIG. 3B is a flow diagram illustrating aspects of one method provided herein for providing the customized search results 126 to the participant 202.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

Referring to FIG. 3A, a routine 300 begins at operation 302, where the context data module 116 receives the context data 122 based on the participation by the participant 202 in the virtual world. In one embodiment, the context data module 116 monitors the locations in the virtual world visited by the avatar 206. For example, the context data 122 may include data specifying that the avatar 206 has visited the NBA virtual world 214. In another embodiment, the context data module 116 monitors the other participants with which the participant 202 interacted or communicated via their respective avatars. For example, interests associated with other participants may also be attributed to the participant 202.

The context data module 116 may also monitor the type of communications made with the other participants. In yet another embodiment, the context data module 116 monitors the commercial transactions made by the participant 202 within the virtual world. For example, the context data 122 may include data specifying the virtual stores visited by the participant 202, the items purchased by the participant 202, the amount of money spent, and the frequency of purchases. In other embodiments, the context data 122 may include any suitable information associated with the participant 202. The context data 122 may also include information separate from the virtual world, such as information provided in a questionnaire filled out by the participant 202 or a HTTP cookie transmitted to the participant 202. Upon receiving the context data 122, the routine 300 proceeds to operation 304.

At operation 304, the context advertising module 112 generates the customized advertisement 124 based on the context data 122. For example, if the participant 202 is located in Seattle and shows an interest in a basketball game between the SEATTLE SUPERSONICS and the HOUSTON ROCKETS, the customized advertisement 124 may be a vacation package including, among other things, airfare from Seattle to Houston and tickets to the basketball game. Upon generating the customized advertisement 124, the routine 300 proceeds to operation 306.

At operation 306, the context advertising module 112 provides the customized advertisement 124 to the participant 202. In one embodiment, the customized advertisement 124 is provided to the participant 202 while the participant 202 is interacting with the virtual world. The customized advertisement 124 may be displayed on the same screen separate from the virtual world or directly within the virtual world. The customized advertisement 124 may be displayed in any suitable multimedia format, such as text, images, audio, video, or a combination thereof. The customized advertisement 124 may also include a link to a website where the participant 202 can purchase the item advertisement in the customized advertisement 124.

Referring to FIG. 3B, a routine 320 begins at operation 322, where context data module 116 receives the context data 122 based on the participation by the participant 202 in the virtual world. Operation 322 is similar to operation 302 in FIG. 3A. Upon receiving the context data 122, the routine 320 proceeds to operation 324, where the search module 114 receives the search term 248 from the participant 202. For example, the participant 202 may input the search term 248 into the input window 244 provided within the virtual world. The routine 320 proceeds to operation 326.

At operation 326, the search module 114 generates customized search results 126 based on the context data 122 as well as the search term 248. By utilizing the context data 122, the customized search results 126 may be more relevant for the participant 202 than conventional search engines. In one embodiment, the customized search results 126 include search results retrieved based on the context data 122 and the search term 248. In another embodiment, the customized search results 126 include search results from a conventional search engine that are ranked based on the context data 122. In yet another embodiment, the customized search results 126 include results retrieved and ranked based on the context data 122 and the search term 248. Upon retrieving the customized search results 126, the routine 320 proceeds to operation 328, where the customized search results 126 are provided to the participant 202.

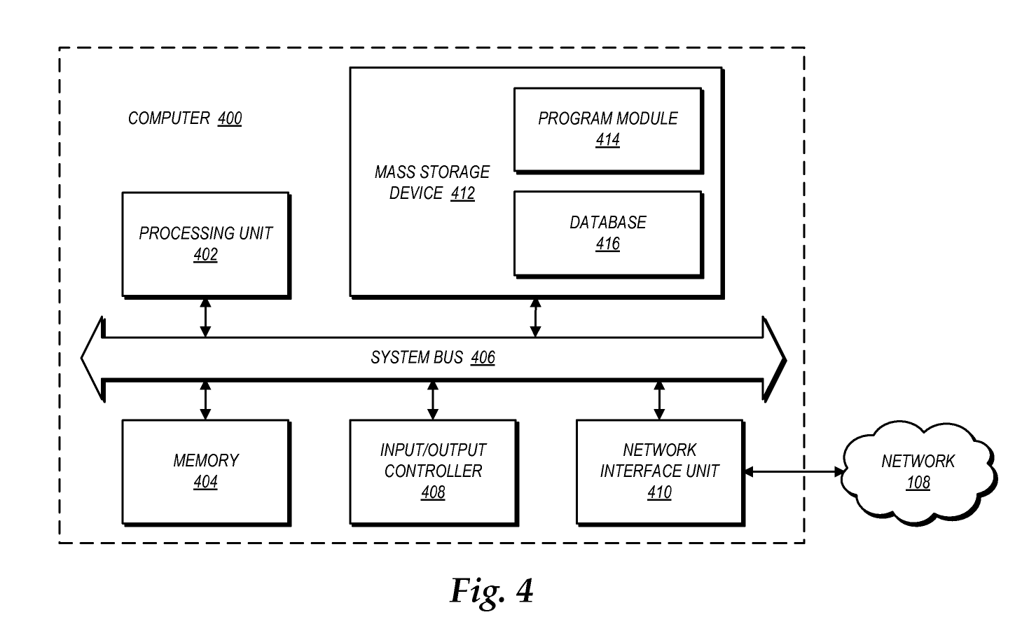

Referring now to FIG. 4, an exemplary computer architecture diagram showing aspects of a computer 400 is illustrated. Examples of the computer 400 may include the server computer 102 and the client device 104. The computer 400 includes a processing unit 402 (“CPU”), a system memory 404, and a system bus 406 that couples the memory 404 to the CPU 402. The computer 400 further includes a mass storage device 412 for storing one or more program modules 414 and one or more databases 416. Examples of the program modules 414 include the advertising module 112, the search module 114, and the context data module 116. An example of the database 416 is the context data database 118. The mass storage device 412 is connected to the CPU 402 through a mass storage controller (not shown) connected to the bus 406. The mass storage device 412 and its associated computer-readable media provide non-volatile storage for the computer 400. Although the description of computer-readable media contained herein refers to a mass storage device, such as a hard disk or CD-ROM drive, it should be appreciated by those skilled in the art that computer-readable media can be any available computer storage media that can be accessed by the computer 400.

By way of example, and not limitation, computer-readable media may include volatile and non-volatile, removable and non-removable media implemented in any method or technology for storage of information such as computer-readable instructions, data structures, program modules, or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 400.

According to various embodiments, the computer 400 may operate in a networked environment using logical connections to remote computers through a network such as the network 108. The computer 400 may connect to the network 108 through a network interface unit 410 connected to the bus 406. It should be appreciated that the network interface unit 410 may also be utilized to connect to other types of networks and remote computer systems. The computer 400 may also include an input/output controller 408 for receiving and processing input from a number of input devices (not shown), including a keyboard, a mouse, a microphone, and a game controller. Similarly, the input/output controller 408 may provide output to a display or other type of output device (not shown).

Based on the foregoing, it should be appreciated that technologies for providing customized content based on context data to a participant via the virtual world are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for providing customized content based on context data from a participant of a virtual world, the method comprising:
receiving the context data based on participation by the participant of the virtual world;
generating the customized content for the participant based on the context data; and
providing the customized content to the participant via the virtual world.

2. The method of claim 1, wherein receiving the context data based on participation by the participant of the virtual world comprises monitoring locations in the virtual world visited by the participant.

3. The method of claim 1, wherein receiving the context data based on participation by the participant of the virtual world comprises monitoring other participants with which the participant communicated within the virtual world.

4. The method of claim 1, wherein receiving the context data based on participation by the participant of the virtual world comprises monitoring commercial transactions made by the participant within the virtual world.

5. The method of claim 1, wherein receiving the context data based on participation by the participant of the virtual world comprises determining a location of the participant.

6. The method of claim 5, wherein determining a location of the participant comprises determining the location of the participant based on an Internet Protocol (IP) address associated with the participant.

7. The method of claim 5, wherein determining a location of the participant comprises obtaining the location of the participant based on a Hypertext Transfer Protocol (HTTP) cookie transmitted to the participant.

8. The method of claim 1, wherein generating the customized content for the participant based on the context data comprises generating a customized advertisement for the participant based on the context data.

9. The method of claim 8, wherein generating a customized advertisement for the participant based on the context data comprises generating the customized advertisement based on locations in the virtual world visited by the participant according to the context data.

10. The method of claim 8, wherein generating a customized advertisement for the participant based on the context data comprises generating the customized advertisement based on other participants with which the participant communicates within the virtual world according to the context data.

11. The method of claim 1, generating the customized content for the participant based on the context data comprises:
receiving a search term from the participant via the virtual world; and
generating customized search results based on the context data and the search term.

12. The method of claim 11, wherein generating customized search results based on the context data comprises generating the customized search results based on locations in the virtual world visited by the participant according to the context data.

13. The method of claim 12, wherein generating customized search results based on the context data comprises ranking the customized search results based on other participants with which the participant communicated within the virtual world according to the context data.

14. A method for providing a customized advertisement to a participant of a virtual world, the method comprising:
receiving context data based on participation by the participant in the virtual world, the context data including at least one of data specifying locations in the virtual world visited by the participant or data specifying other participants with which the participant communicates within the virtual world;
generating the customized advertisement for the participant based on the context data; and
providing the customized advertisement to the participant via the virtual world.

15. The method of claim 14, wherein the context data further specifies a location of the participant, and wherein the customized advertisement is location-specific with respect to the location of the participant.

16. The method of claim 14, wherein the customized advertisement includes a link to a website to purchase an item advertised in the customized advertisement.

17. The method of claim 14, wherein providing the customized advertisement to the participant via the virtual world comprises providing the customized advertisement to the participant while the participant participates in the virtual world.

18. The method of claim 14, wherein the context data includes data collected from a questionnaire filled out by the participant.

19. A computer-readable medium having computer-executable instructions stored thereon which, when executed by a computer, cause the computer to:
receive context data based on participation by a participant of a virtual world, the context data including at least one of data specifying locations in the virtual world visited by the participant or data specifying other participants with which the participant communicated within the virtual world;
receive a search term from the participant via the virtual world;
generate customized search results for the participant based on the context data and the search term; and
provide the customized search results to the participant via the virtual world.

20. The computer-readable medium of claim 19 having further computer-executable instructions stored thereon which, when executed by a computer, cause the computer to rank the customized search results for the participant based on the context data.
